(19) United States
(12) Patent Application Publication
(10) Pub. No.: US 2023/0281603 A1
(43) Pub. Date: Sep. 7, 2023

(54) SYSTEMS AND METHODS FOR GENERATING AND DISTRIBUTING DIGITAL CONTRACT TOKENS

(71) Applicant: STF Labs Pte. Ltd., Valley Point (SG)

(72) Inventors: Riccardo Paolo SPAGNI, Wappingers Falls, NY (US); Ivan BRIGHTLY, West Wareham, MA (US)

(73) Assignee: STF Labs Pte. Ltd., Valley Point (SG)

(21) Appl. No.: 18/114,638

(22) Filed: Feb. 27, 2023

Related U.S. Application Data
(60) Provisional application No. 63/317,375, filed on Mar. 7, 2022.

(51) Int. Cl. G06Q 20/36; G06Q 20/40; G06Q 20/38

(52) U.S. Cl. CPC G06Q 20/3672; G06Q 20/3827; G06Q 20/3829; G06Q 20/405; G06Q 2220/00

(57) ABSTRACT

Systems and methods for generating and distributing digital contract tokens that identify licensing rights for digital assets are presented herein. In one or more examples, a digital contract token can represent contract terms for a transaction between a first user and a second user. The digital contract token can, in one or more examples, comprise metadata relating to contract terms of a given transaction. In one or more examples, the digital contract token can be transmitted to a distributed ledger network wherein the digital contract token can be authenticated and transmitted to a digital wallet of the second user.

### CROSS-REFERENCE TO RELATED APPLICATIONS

This application claims the benefit of U.S. Provisional Application No. 63/317,375, filed Mar. 7, 2022, the entire contents of which is incorporated herein by reference.

### FIELD

This disclosure relates to systems and methods for generating and distributing digital contract tokens that identify licensing rights for digital assets.

### BACKGROUND

Digital media licensing marketplaces connect contributors who create digital media to buyers who want to purchase ownership rights in the digital media. A traditional digital media licensing marketplace generally involves three entities: (1) media contributors, (2) a media marketplace administrator, and (3) media license buyers. These entities can be connected via a web-based platform such as a licensing marketplace website that facilitates licensing transactions. A traditional licensing transaction hosted by a licensing marketplace website involves receiving digital media from a contributor, publishing the media in the marketplace to indicate it is available, and licensing the media to a buyer. In such transaction, the media marketplace administrator and the buyer will be in privity of contract. However, the media contributor is not a party to the contract. In fact, the media contributor does not interact with the buyer at all and has no influence in determining the licensing conditions of each license. Instead, the media contributor may receive a royalty each time their media is licensed, based on a rate determined by the media marketplace administrator.

Media contributors have few alternatives to licensing their digital media to buyers. A media contributor may opt to create a media gallery on their own website and individually negotiate licenses with each buyer in a peer-to-peer system. However, this arrangement presents the additional difficulty in that the media contributor will have to draw buyers to their website by some form of advertising or notoriety. Additionally, if all media contributors opted to individually market their media on their own websites rather than relying on a central media marketplace, media buyers would be forced to visit a myriad of individual websites in order to find and license media. This also introduces a security issue, as without a central administrator, both contributor and buyers may doubt the legitimacy of the licensing transaction.

A license for digital media may specify, for example, how the image can be used, whether the buyer’s usage rights are exclusive or non-exclusive, the duration of the license, where the digital media can or cannot be used, who may use the digital media, additional specific limitations, etc. An established media marketplace website managed by an administrator may negotiate the license terms for available media in advance and obtain permission for broad usage of digital media by buyers. However, in a peer-to-peer arrangement, buyers may not be familiar with the different types of licenses possible and which ones are necessary for their intended use. Similarly, media contributors may not be familiar with the types of releases required for their own digital media. For example, digital media including a recognizable faces cannot be licensed and used without those individuals signing a model release form. Thus, both buyers and sellers in peer-to-peer systems may suffer without the structure and management provided by an administrator.

Moreover, media contributors in a peer-to-peer system lose the benefit of the administrator of a media marketplace monitoring and enforcing licensing terms. Many major digital media marketplaces will both monitor buyers’ use of licensed media and enforce any deviation from the license terms. Ideally, contributors will license their digital media to as many buyers as possible. However, that creates a large burden with respect to monitoring and enforcement. Thus, media contributors may be wary of listing their digital media in a personal gallery in a peer-to-peer system because they do not know how to enforce licensing terms or do not want to do so.

### SUMMARY

Accordingly, systems and methods for generating and distributing secured contract tokens that identify licensing rights for digital assets are presented herein. In one or more examples, a system can generate a smart contract between a contributor and a user which can delineate licensing terms for use of a digital asset. Once the licensing contract has been generated, in one or more examples, the licensing contract can be embedded within a secured contract token. In one or more examples, the contract token can be secured using a distributed ledger platform (DLP), and distributed to a digital wallet of the user maintained by the DLP.

In one or more examples, a method for generating a digital contract token comprises: receiving contract terms for a transaction between a first user and a second user, wherein the transaction comprises an asset owned by the first user that is being conveyed to the second user, generating an executable file that is configured to be executed by a computing processor based, at least in part, on the received contract terms, storing the executable file in a memory, generating a digital contract token, wherein the digital contract token is an electronic file comprising metadata, wherein a content of the metadata is based on the received contract terms and the generated executable file, transmitting the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process, receiving a confirmation from the distributed ledger network that the transaction was authenticated, and upon receiving the confirmation, transmitting the generated digital contract token to a digital wallet of the second user.

Optionally, each computing node of the plurality of computing nodes of the distributed ledger network is configured to create the local copy of the electronic ledger by applying a cryptographic hash function to the data received by the distributed ledger network and storing an output of the cryptographic hash function in the local copy of the electronic ledger.

Optionally, the consensus process involves each computing node of the plurality of computing nodes of the distributed ledger network determining if the output of the cryptographic hash function stored in each local copy at each computing nodes of the plurality of computing nodes of the distributed ledger network are in agreement with each other, and wherein if it is determined that each local copy at each computing node of the plurality of computing nodes of the distributed ledger network are in agreement with each other, the transaction is authenticated.

Optionally, the distributed ledger network comprises a read-only database.

Optionally, the contract terms comprise one or more conditions for the second user to license an asset from the first user.

Optionally, the contract terms include at least some terms populated by a license-builder and agreed-upon by the first user and the second user.

Optionally, the method comprises associating a public key of a public key cryptography scheme with the digital contract token and associating a private key of the public key cryptography scheme with the digital contract token and with the second user, the private key enabling the second user to distribute the digital contract token.

Optionally, generating an executable file comprises transforming the contract terms into executable software code including one or more trigger conditions and corresponding consequences, such that if a trigger condition occurs, the corresponding consequence will automatically be executed.

In one or more examples, a system for generating a digital contract token comprises: a memory, one or more processors, and one or more programs, wherein the one or more programs are stored in the memory and configured to be executed by the one or more processors, the one or more programs when executed by the one or more processors cause the processor to: receive contract terms for a transaction between a first user and a second user, wherein the transaction comprises an asset owned by the first user that is being conveyed to the second user; generate an executable file that is configured to be executed by a computing processor based, at least in part, on the received contract terms; store the executable file in a memory; generate a digital contract token, wherein the digital contract token is an electronic file comprising metadata, wherein a content of the metadata is based on the received contract terms and the generated executable file; transmit the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process; receive a confirmation from the distributed ledger network that the transaction was authenticated; and upon receiving the confirmation, transmit the generated digital contract token to a digital wallet of the second user.

Optionally, each computing node of the plurality of computing nodes of the distributed ledger network is configured to create the local copy of the electronic ledger by applying a cryptographic hash function to the data received by the distributed ledger network and storing an output of the cryptographic hash function in the local copy of the electronic ledger.

Optionally, the consensus process involves each computing node of the plurality of computing nodes of the distributed ledger network determining if the output of the cryptographic hash function stored in each local copy at each computing nodes of the plurality of computing nodes of the distributed ledger network are in agreement with each other, and wherein if it is determined that each local copy at each computing node of the plurality of computing nodes of the distributed ledger network are in agreement with each other, the transaction is authenticated.

Optionally, the distributed ledger network comprises a read-only database.

Optionally, the contract terms comprise one or more conditions for the second user to license an asset from the first user.

Optionally, the contract terms include at least some terms populated by a license-builder and agreed-upon by the first user and the second user.

Optionally, the one or more programs when executed by the one or more processors cause the processor to associate a public key of a public key cryptography scheme with the digital contract token and associate a private key of the public key cryptography scheme with the digital contract token and with the second user, the private key enabling the second user to distribute the digital contract token.

Optionally, generating an executable file comprises transforming the contract terms into executable software code including one or more trigger conditions and corresponding consequences, such that if a trigger condition occurs, the corresponding consequence will automatically be executed.

In one or more examples, computer readable storage medium stores one or more programs for generating a secured contract token, the one or more programs comprising instructions which, when executed by an electronic device with a display and a user input interface, cause the device to: receive contract terms for a transaction between a first user and a second user, wherein the transaction comprises an asset owned by the first user that is being conveyed to the second user, generate an executable file that is configured to be executed by a computing processor based, at least in part, on the received contract terms, store the executable file in a memory, generate a digital contract token, wherein the digital contract token is an electronic file comprising metadata, wherein a content of the metadata is based on the received contract terms and the generated executable file, transmit the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process, receive a confirmation from the distributed ledger network that the transaction was authenticated, and upon receiving the confirmation, transmit the generated digital contract token to a digital wallet of the second user.

Optionally, each computing node of the plurality of computing nodes of the distributed ledger network is configured to create the local copy of the electronic ledger by applying a cryptographic hash function to the data received by the distributed ledger network and storing an output of the cryptographic hash function in the local copy of the electronic ledger.

Optionally, the consensus process involves each computing node of the plurality of computing nodes of the distributed ledger network determining if the output of the cryptographic hash function stored in each local copy at each computing nodes of the plurality of computing nodes of the distributed ledger network are in agreement with each other, and wherein if it is determined that each local copy at each computing node of the plurality of computing nodes of the distributed ledger network are in agreement with each other, the transaction is authenticated.

Optionally, the distributed ledger network comprises a read-only database.

Optionally, the contract terms comprise one or more conditions for the second user to license an asset from the first user.

Optionally, the contract terms include at least some terms populated by a license-builder and agreed-upon by the first user and the second user.

Optionally, the one or more programs comprise instructions which, when executed by the electronic device, cause the device to: associate a public key of a public key cryptography scheme with the digital contract token and associate a private key of the public key cryptography scheme with the digital contract token and with the second user, the private key enabling the second user to distribute the digital contract token.

Optionally, generating an executable file comprises transforming the contract terms into executable software code including one or more trigger conditions and corresponding consequences, such that if a trigger condition occurs, the corresponding consequence will automatically be executed.

### BRIEF DESCRIPTION OF THE FIGURES

The invention will now be described, by way of example only, with reference to the accompanying drawings, in which:

FIG. 1A illustrates an exemplary computing system for facilitating the generation and distribution of secured contract tokens using a smart contract licensing marketplace, in accordance with some examples.

FIG. 1B illustrates an exemplary distributed ledger platform, in accordance with some examples.

FIG. 2 illustrates an exemplary process for mining a secured contract token on a distributed ledger platform, according to examples of the disclosure.

FIG. 3 illustrates an exemplary process for licensing a digital asset, in accordance with some examples.

FIG. 4 illustrates an exemplary process for executing a licensing transaction, in accordance with some examples.

FIG. 5 illustrates an exemplary process for a user to purchase licensing rights for a digital asset, in accordance with some examples.

FIG. 6 illustrates an exemplary process for a contributor to license a digital asset, in accordance with some examples.

FIG. 7 illustrates an exemplary process for a user to transfer a cryptographically secured contract token to a new user, in accordance with some examples.

FIG. 8 illustrates an exemplary process for accessing information associated with a contract token, in accordance with some examples.

FIG. 9 illustrates an exemplary computing device, in accordance with some examples.

### DETAILED DESCRIPTION

In the following description of the disclosure and examples, reference is made to the accompanying drawings in which are shown, by way of illustration, specific examples that can be practiced. It is to be understood that other examples can be practiced, and changes can be made, without departing from the scope of the disclosure.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations executed on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present disclosure include process steps and instructions described herein in the form of an algorithm. It should be noted that the process steps and instructions of the present disclosure could be embodied in software, firmware, or hardware, and, when embodied in software, they could be downloaded to reside on and be operated from different platforms used by a variety of operating systems.

The present disclosure also relates to a device for performing the operations herein. This device may be specially constructed for the required purposes or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the present disclosure as described herein.

Content creators such as musicians, painters, photographers, and writers often create tangible media such as CDs, paintings, printed photos, and books. Many content creators also create digital media such as digital images, music, video games, and e-books which can be stored on a computing device and do not require a physical medium for their distribution. Both tangible and digital media can be sold to consumers so that the content creator can earn money for their creative works.

Generally, creators prefer to monetize their creative works via licensing the works to buyers rather than transferring ownership of the work. The owner of a work has the right to use that work in a variety of ways. For example, the owner has the right to display the work publicly, the right to distribute that work, the right to use that work for commercial or retail purposes, the right to create derivative works based on the work, etc. In comparison, the licensee of a work has the right to use that work only in accordance with their license. For example, a license could permit a licensee to use a work for “for personal use only,” which thereby reserves all other rights to the owner, or permit the licensee to use the work for commercial purposes such as for marketing or advertisements.

By licensing a work, the owner of the work can pursue a legal action for breach of contract. Licensing is particularly useful with respect to digital media, because digital media can be more readily copied than tangible media. This is because digital media is stored on computing device, and duplicating digital media on a computing devices is a relatively simple process. Furthermore, digital media is often distributed using internet-based platforms, which are highly accessible and can be difficult to police for illicit copying. Thus, digital media is more susceptible to being copied and distributed without permission or without remuneration to the creator than tangible works. This property of digital media often makes it difficult for digital media creators to independently monetize their digital works, because of the large burden of monitoring each licensee’s use and pursuing enforcement against those licensees who use works beyond the terms of their license.

Digital media creators thus often look to established internet licensing marketplaces which can create and enforce licensing contracts with licensees. Established internet licensing marketplaces also provide the additional benefit of centralized marketing. By relying on a centralized marketplace, digital media creators can avoid marketing costs associated with hosting their digital assets on a personal website. Centralized digital media licensing marketplaces generally involve an administrator that conducts licensing transactions on behalf of the media contributor (creator) and a user (buyer). The administrator of these centralized media licensing marketplaces negotiate a licensing agreement between the administrator and the media contributor and then a separate licensing agreement between the administrator and the user. In such transactions, the media contributor and the user do not interact with one another. Thus, digital media licensing marketplaces with a central administrator prevent peer-to-peer licensing between media contributors and users.

Media contributors may thus seek out peer-to-peer licensing platforms in order to preserve their control over and maximize their monetization of the licensing of their digital assets. However, straying from a centralized marketplace with an administrator places the burden of generating licensing contracts and monitoring those contracts on the media contributors. Accordingly, a centralized marketplace that provides the benefits of facilitating licensing transactions while still enabling contributors to retain their control over individual licenses would provide the benefits of both centralized and peer-to-peer licensing schemes.

A distributed ledger technology platform can present a viable web-based platform for media contributors to securely conduct licensing transactions for their digital assets. Distributed ledger technology platforms are peer-to-peer networks with secure, verifiable data blocks. A distributed ledger platform (DLP) can be used to create and maintain a secure distributed ledger which contains a verified record of information. Maintaining a distributed ledger involves repetitively publishing data to be added to the ledger to each computing node within the network, those computing nodes creating an immutable block corresponding to the data and verifying that the local data block is in consensus with the data block at other nodes within the system, and then appending that verified and immutable data block to the append-only ledger. Accordingly, a DLP can be used to create a chain of blocks containing verified and immutable data records regarding licensing transactions. Because each new data block appended to the ledger is independently verified by a series of distributed computing nodes, the DLP is immune to centralized data attacks and nearly impossible to hack or alter because that would require altering data on every single computing node within the DLP.

A DLP can be used to store a smart contract within a block in the chain. A smart contract includes executable software that can operate autonomously. Accordingly, smart contracts can autonomously enforce contract provisions without requiring monitoring or management by either contracting party. For example, a smart contract can include standard “if-then” conditions such that once the condition occurs, the smart contract automatically triggers the result. For example, a smart contract may include instructions that every time a given token is conveyed, the original creator of the token should receive a royalty percentage of that conveyance.

DLPs can also facilitate the creation of a non-fungible token (NFT) having some intrinsic value that can be securely traded, licensed, or sold without requiring an intermediary to facilitate or secure the transaction. Compared to fungible tokens, such as a unit of currency which can be exchanged for an equal-value unit of currency without any distinction, non-fungible tokens are unique in that any one NFT is not necessarily equal in value to another NFT.

Transactions involving an NFT secured on a DLP are “secure” because ownership of a given NFT can be published to the DLP (by being recorded in a block) and verified by every node in the network as explained above. As an NFT is transferred, the transaction can similarly be published to the DLP and verified by the network nodes. Such process ensures that a given NFT can only exist in a singular form and therefore cannot be copied or “spent” twice.

The market for NFTs currently includes tokens corresponding to art and other media. In addition to tokens corresponding to media, however, NFTs can also be useful based on their immortalized and verifiable existence. That is, an NFT can be useful solely for the information it contains, rather than the media it represents. Combining the underlying NFT scheme of creating an immutable token with a smart contract can thus create a publicly-available, secure, and verifiable platform for facilitating and managing licensing transactions, with the licensing transaction embedded into the non-fungible contract token. As explained above, traditional media licensing websites require an administrator to manage licensing transactions between a contributor and a buyer. Smart contracts however, do not require an administrator to oversee or enforce contract terms. Moreover, contract tokens secured using a DLP remove the necessity for a trusted intermediary to administrate a given transaction. According, a smart contract immortalized in a secured contract token enables peer-to-peer licensing transactions directly between the contributor (the licensor) and the media buyer (the licensee).

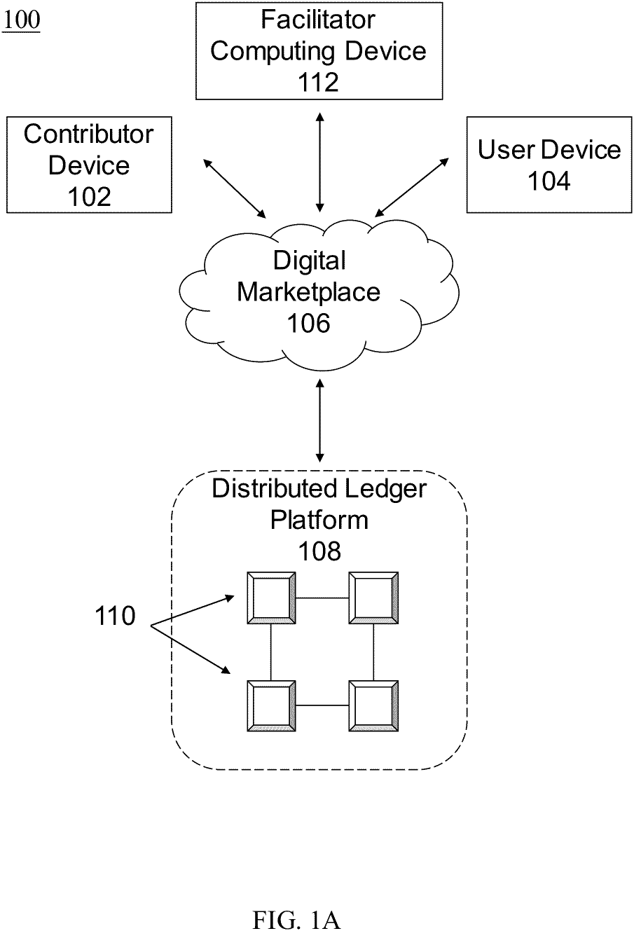

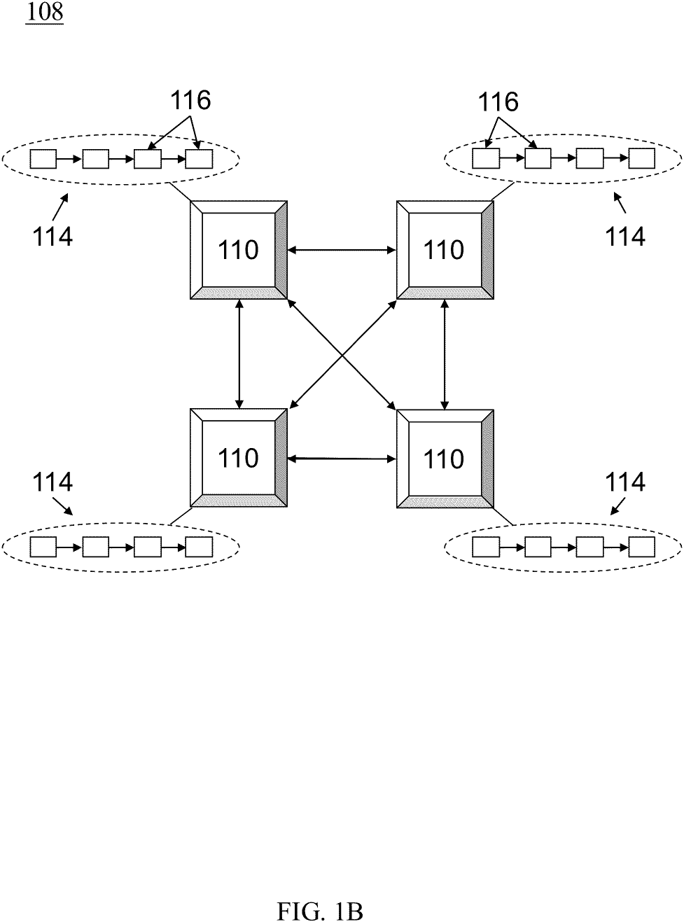

FIG. 1A illustrates an exemplary computing system 100 for facilitating the generation and distribution of secured contract tokens using a smart contract licensing marketplace, in accordance with some examples. In the examples described below, the term “smart contract” is used to indicate executable software that can be stored in a medium and operate autonomously. Similarly, the term “secured contract token” is used to identify a non-fungible, one-of-one token with intrinsic value that cannot be altered.

As discussed above, smart contracts can be used to generate licensing contracts for digital assets between a contributor and a user that autonomously enforce the terms of the contract. Furthermore, the contract terms of the smart contract can be embedded within a contract token secured using a DLP, which thereby ensures the contract terms contained within the token cannot be altered, are publicly accessible, and are independently verifiable. Because a secured contract token can be used by media contributors and users (licensees) to denote the terms of a smart contract corresponding to a licensing transaction regarding digital assets, in one or more examples, a marketplace for licensing digital assets can be established so that users can license digital assets via smart contracts in secure and verifiable manner. Such licensing marketplace platform can thus remove the necessity for a third-party to administrate the transaction. Furthermore, because a smart contract can be used to autonomously enforce the terms of a contract, a smart contract corresponding to a secured contract token can remove the necessity for any part to monitor licensees and enforce contract terms. Accordingly, a contributor need not rely on a third party administrator to oversee any licenses, without taking on the burden of monitoring and enforcement herself.

As shown in FIG. 1A, the computing system 100 can include a contributor device 102 and a user device 104 that have access to a digital marketplace 106. The digital marketplace 106 can be an online marketplace that includes an inventory of digital assets available to license. In one or more examples, the computing system 100 can include a facilitator computing device 112 that is configured to manage the digital marketplace 106. By creating a centralized digital marketplace for contributors and buyers to execute licensing transactions, the digital marketplace can improve the apparent legitimacy of those transactions. That is, the digital marketplace can foster increased trust among the parties with respect to the legitimacy of the licensing transaction, relative to a transaction that is not executed using a centralized platform.

Although only one contributor device 102 and one user device 104 are shown in FIG. 1A, it should be appreciated that any number of contributor devices 102 and/or user devices 104 can access the digital marketplace 106. The contributor device 102 can represent the computing system of a digital asset contributor who owns one or more digital assets that the contributor wants to license via the digital marketplace 106. In one or more examples, the owner of a license may offer to sell or trade the license within digital marketplace 106. Thus, a contributor device 102 within computing system can also include the device of the owner of a license to one or more digital assets, but whom does not own the digital asset. Digital assets can include, as non-limiting examples, digital photographs, digital art, music files, video files, software, video games, electronic documents such as articles, essays, journals, etc. User device 104 can represent the computing system of a user who wants to purchase a license to use digital assets via the digital marketplace 106.

In one or more examples, the digital marketplace 106 can be communicatively connected to a distributed ledger platform 108 which includes one or more computing nodes 110. The distributed ledger platform 108 can be a peer-to-peer network as is known to those skilled in the art. In one or more examples, the computing nodes 110 of the distributed ledger platform 108 can implement known consensus algorithms to validate information submitted to the distributed ledger platform 108.

FIG. 1B illustrates an exemplary distributed ledger platform 108, in accordance with some examples. In one or more examples, distributed ledger platform 108 may include one or more computing nodes 110. The computing nodes can be distributed across one or more locations and/or processors owned by one or more entities in a decentralized manner. In one or more examples, the computing nodes 110 can include a local ledger 104 that stores and records data. In one or more examples, data can be stored within the ledger 104 in one or more sequential blocks 116.

In one or more examples, the computing nodes 110 can each maintain a local append-only ledger 104 and follow the same consensus protocol (e.g., the same cryptographic hash function) to ensure consensus between the data contained in each local ledger 104 and the data stored in each ledger 104 located at the other computing nodes 110. After ensuring consensus, the distributed ledger platform 108 may generate a single data record by collecting ledger data from each ledger 104 at each computing node 110, and using the data that the most number of ledgers 104 agree on. Because each computing node 110 independently appends data to the local ledger 104 and then performs the same consensus protocol, it is nearly impossible to forge data added to the distributed ledger platform 108 because that would require forging the data added to every single computing node 110 within the platform. Accordingly, the distributed ledger platform 108 enables the creation of a secure distributed ledger that immutably records data.

The process of appending data to each ledger 104 within the distributed ledger platform 108 and then reaching consensus regarding the synchronicity of the ledger among each computing node 110 can be referred to as “mining” a new block on the distributed ledger 104. Mining a new block on the distributed ledger 104 is thus a method to ensure data is cryptographically secure and immutable. The distributed ledger platform 108 can be employed in a digital licensing system such as system 100 of FIG. 1A. Accordingly, in one or more examples, distributed ledger platform 108 can operate as described above to mine a secured contract token corresponding to a licensing transaction.

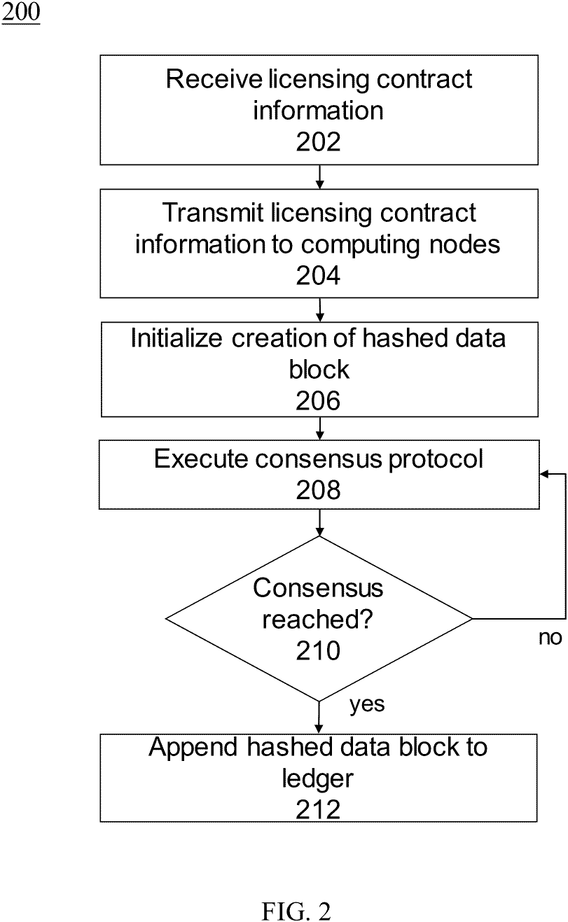

FIG. 2 illustrates an exemplary process 200 for mining a secured contract token on a distributed ledger platform, according to examples of the disclosure. In one or more examples, the process 200 can begin at step 202 with the distributed ledger platform 108 receiving licensing contract information. The licensing contract information can include a smart contract that corresponds to the terms of the contract and/or a contract token representative of the licensing transaction. After receiving the licensing contract information, the licensing contract information can be transmitted to each computing node 110 within the distributed ledger platform 108 at step 204.

After receiving data (e.g., the licensing contract information) to be added to the ledger, the process 200 can move to step 206 where each computing node 110 can initialize the creation of a new data block. Initializing the creation of a new data block can include creating a new block, storing the data to be added to the ledger in the new block, and applying a cryptographic hash function to generate a hashed data block 116.

After generating the hashed data block 116, the process can move to step 208 where each computing node 110 can execute the consensus protocol. The consensus protocol may require the computing nodes 110 to exchange ledger information with other computing nodes 110 in order to verify consensus between the data stored in each ledger 104. In one or more examples, the computing nodes 110 may verify consensus using Byzantine Fault Tolerance (BFT), Proof of Work (POW), and/or Proof of Stake (POS).

Part of executing the consensus protocol can include determining whether consensus is reached among the computing nodes 110 as shown at step 210. If consensus is not reached, indicating that the new data block at one or more computing nodes 110 differs from the new data block at one or more other computing nodes 110, the process can move back to step 208 to re-execute the consensus protocol.

Alternatively, if consensus is reached at step 210, indicating the new data block initialized at a given computing node 110 is in agreement with the new data block at other computing nodes 110, then the process can move to step 212 where each computing node 110 can append the hashed data block to the local ledger 104. In one or more examples, the cryptographic hash function can be based at least in part on data already stored in the ledger 104. By creating a hashed data block 116 using data already stored in the ledger 104 and storing the hashed data block 116 in an append-only ledger 104 after verifying the consensus regarding the contents of the data block, the distributed ledger platform 108 can create a verified sequential chain of data which represents an immutable record of historical ledger information.

The mining process of creating and appending new data to the chain can be especially useful for creating a non-fungible token and memorializing the existence of that token. With respect to licensing transactions, the distributed ledger 108 can be used to mine a non-fungible contract token indicative of a licensing contract for digital media such that the token is both cryptographically secure. Accordingly, the mining process shown in FIG. 2 can be incorporated into licensing transactions after the parties to the transaction have agreed upon the license terms and selected the digital asset which is the subject of the transaction.

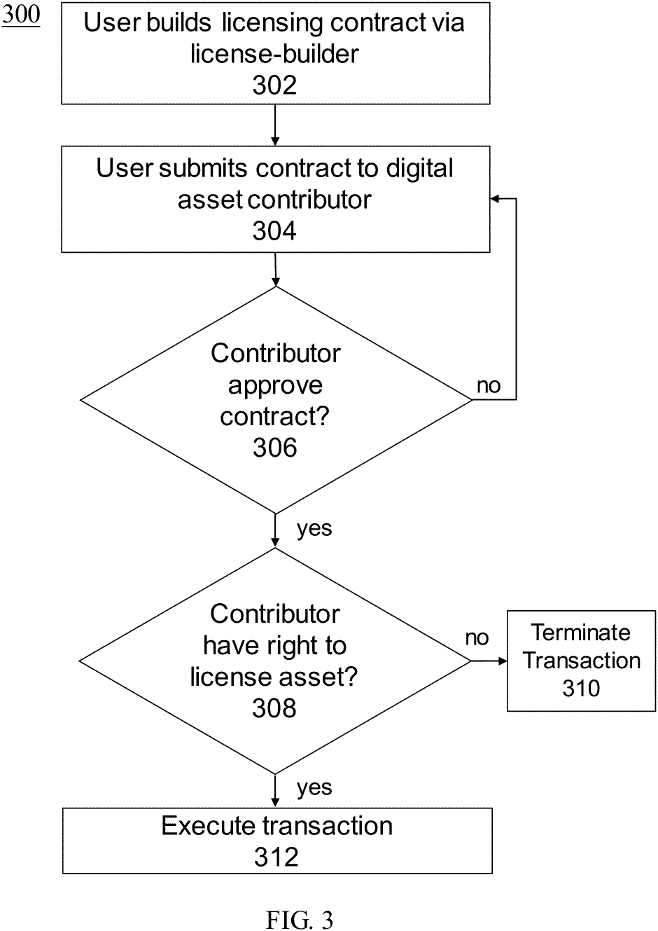

FIG. 3 illustrates an exemplary process 300 for a user to license a digital asset, in accordance with some examples. Process 300 can be conducted using system 100 shown in FIG. 1A. Process 300 begins at step 302, where a user builds a licensing contract via a license-builder. The user may build the licensing contract using user device 104. The license-builder can be provided to users of the system 100 via the digital marketplace 106 and implemented by the facilitator computing device 112. It should be noted, however, that licensing contracts are used as examples only and should not be construed as limiting the disclosure. In one or more examples, other types of contracts outside of the licensing context can also be executed using the systems and methods disclosed herein.

In one or more examples, the license-builder can include an interface displayed to a contributor on a contributor device 102 and/or a user on a user device 104. The license builder can enable the contributor and/or user to build a licensing contract tailored to their specific needs/preferences. In non-limiting examples, the license-builder can enable users and/or contributors to create a licensing contract using a non-modifiable standard form contract, a customizable standard form contract, and/or an entirely custom contract. As contributors and users in a peer-to-peer licensing system may not be familiar with the different types of licenses available or which licenses terms are pertinent to their intended use, the license-builder can provide helpful structure and guidance for the contributor and/or user to build an appropriate license for their transaction. In one or more examples, a third party service can host and facilitate the license-builder, and thus the user can build a licensing contract at step 302 using the third party license-builder.

In one or more examples, when building a licensing contract via the license builder at step 302 of process 300, a user may build a licensing contract using an existing non-modifiable licensing contract. When “building” a non-modifiable licensing contract, the user may populate required fields such as the user’s or licensee’s name and identification of the digital asset, without editing any existing terms of the contract. The existing terms may be generated by the contributor in advance. For example, the contributor may specify that a certain digital asset can only be licensed using a non-modifiable licensing contract generated by the contributor and made available to the user via the digital marketplace 106. Existing terms included in the non-modifiable licensing contract may include, in non-limiting examples, whether the license is exclusive or non-exclusive, which geographical territories the license authorizes the licensee to exert the license in, permissible uses of the digital asset, attribution requirements, ability of the licensee to create derivative works, duration, termination, assignment and/or transfer stipulations, payment, royalties, etc.

Alternatively, at step 302, the user may build a licensing contract using an existing customizable licensing contract. When building a licensing contract using an existing customizable licensing contract, the user may populate required fields and customize one or more of the contract according to the user’s intended use of the digital asset. In another example, at step 302 the user may build an entirely custom licensing contract without relying on any existing terms or structure. In one or more examples, when building a custom licensing contract, the user may be presented with information indicating that certain terms must be added to the contract, such as the parties, price, type of use, duration, etc.

After building a licensing contract at step 302, the process can move to step 304 where the user submits the contract to the digital asset contributor. The user can submit the contract to the digital asset contributor via the digital marketplace 106 using user device 104. In one or more examples, the facilitator computing device may verify that all essential contracting terms are included in a licensing contract generated by a user before transmitting the contract to a contributor. Alternatively, the licensing contract may be immediately transmitted to the contributor of the digital asset by way of the digital marketplace 106 and the contributor device 102.

After the user submits the contract to the digital asset contributor at step 304, the process can move to step 306 where the process can determine whether the contributor approves the contract. The digital asset contributor can, in one or more examples, reject the licensing contract submitted by the user. With a rejection, the contributor may include comments or suggested revisions to the licensing contract which the contributor can transmit back to the user. The user may then revise the contract and re-submit the contract to the contributor. Alternatively, the user may abandon the licensing contract and terminate the transaction.

If the contributor approves of a licensing contract submitted by a user at step 306, the process 300 can move to step 308 wherein a determination is made as to whether the contributor has the right to license the asset. In one or more examples, to determine whether the contributor has the right to license a given digital asset, the system 100 may assess whether the contributor involved in the transaction is the contributor who originally submitted the asset to the digital marketplace 106. Determining whether the contributor has the right to license a given digital asset can, in one or more examples, include querying the computing nodes in a DLP to determine whether the contributor has already granted a different user an exclusive license for the digital asset.

If the process 300 determines that the contributor does not have a right to license the asset at step 308, the process 300 can move to step 310 and terminate the transaction. When terminating the transaction at step 310, the system can notify the user that the licensing transaction failed by displaying a notification on the user device 104. Alternatively, if the process 300 determines that the contributor does have a right to license the asset at step 308, the process can alternatively move to step 312 and execute the transaction.

The licensing transaction can be executed via the system 100 of FIG. 1. In one or more examples, the facilitator computing device 112 may facilitate the execution of the licensing transaction by generating a smart contract and contract token corresponding to the license terms, relying on a DLP such as distributed ledger platform 108 to mine a record of the transaction, and ensuring that payment is transferred to the contributor and the digital media and contract token are transmitted to the user. In other examples, the facilitator computing device 112 may host a computer program which automatically ensures the appropriate steps are followed in order to execute the transaction.

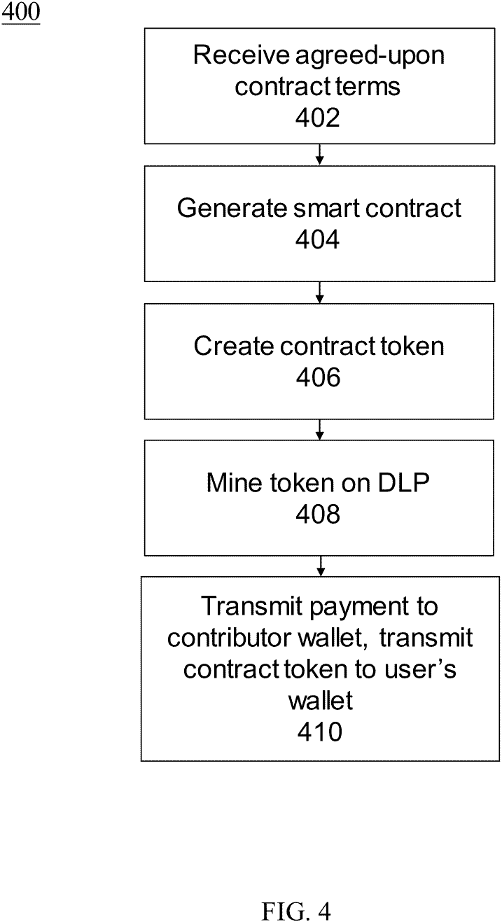

FIG. 4 illustrates an exemplary process 400 for executing a licensing transaction, in accordance with some examples. The process 400 of FIG. 4 can be performed as part of executing the transaction in step 312 of process 300 of FIG. 3. After a contributor and user agree on the terms for a contract, the agreed-upon contract terms are received at step 402. As explained above, the agreement between the contributor and the user can occur in various ways. In one example, the user can build a custom licensing contract and transmit that contract to the contributor for approval. The contributor may approve or deny the contract, and may provide feedback to the user or suggest edits to one or more contract terms. In another example, the contributor may specify that a given digital asset can be licensed only using a particular non-modifiable standard form contract, and if the user selects that standard form contract it may be automatically approved by the contributor. In one or more examples, a third party service can host and facilitate the licensing transaction process, and thus receiving agreed-upon contract terms at step 402 can include receiving the contract terms from a contributor and/or user.

Once the contract terms are received at step 402, the process 400 can move to step 404 and generate a smart contract. In one or more embodiments, the license-builder feature offered via the digital marketplace 106 of system 100 can be configured such that any license built via the license-builder will have contract terms that can be transformed into executable software code that is representative of the license and can be automatically executed. Transforming a contract into a smart contract can, in one or more examples, require translating the contract terms into executable software code with enforceable if-then terms. For example, the contributor of a digital asset may stipulate that any one license of the asset can only last thirty days, and the contract can transformed after it is generated into executable code with a condition that will remove the license token from the user’s digital wallet for after thirty days. Such if-then conditional terms can be included for one or more terms of the contract. Beneficially, a smart contract can automatically enforce a contract and thus relieve the contributor of the burden of overseeing and enforcing each individual license.

After generating a smart contract at step 404, the process 400 can move to step 406 and create a contract token. A contract token created via process 400 can be a non-fungible digital object that can be cryptographically secured via a DLP, as explained above. In one or more examples, the contract terms and/or the smart contract can be embedded in the metadata of the contract token.

After creating the contract token at step 406, the process 400 can move to step 408 to mine the token using a DLP (i.e., distribute data corresponding to the contract token to the DLP so that the DLP can append the data to a distributed ledger). In one or more examples, mining can involve following the steps of process 200 of FIG. 2 including receiving data and transmitting the data to computing nodes within the DLP which the computing nodes then use to initialize the creation of a new data block, executing a consensus protocol to ensure consensus is reached with respect to the data block to be appended to the ledger, and then appending the new data block to the ledger.

In one or more examples, the mining process of step 406 can be performed using the distributed ledger platform 108 shown in FIG. 1B. For example, data corresponding to the contract token can be transmitted to the distributed ledger 108 and then distributed to each computing node 110. The computing nodes 110 can initialize the creation of a hashed data block 116 containing the data corresponding to the contract token and then execute a known consensus protocol and ensure consensus is reached before appending the hashed data block 116 to the ledger 114.

In one or more examples, the data transmitted to the DLP at step 408 can include a smart contract related to the contract terms and a contract token that gives the token holder an enforceable license to use a digital asset. Accordingly, the step 408 of mining the contract token on the DLP can include creating a cryptographically secured public record of the licensing transaction. In one or more examples, mining the token at step 408 will include creating a new block on the DLP that does not contain any other information. Alternatively, mining the token at step 408 may include adding the information indicative of the transaction to a block that includes other information. In one or more examples, the contract token can be mined to the distributed ledger 108 via process 400 which can involve validating the transaction by each computing node 110 of the distributed ledger platform 108 of the system 100, as discussed above. In one or more examples, concluding the step of mining the token at step 408 may include receiving a confirmation that the transaction was validated by the distributed ledger platform 108. Receiving this confirmation may be required before the process 400 can move to step 410.

In one or more examples, the contract token created at step 406 and mined to the DLP at step 408 may include a reference to the digital media that is the object of the license. The reference to the digital media may be contained within the metadata of the contract token. To prevent unauthorized copying of the digital media, the digital media may be cryptographically protected by hashing. For example, if a particular contract token is for a video, the video may be contained within the metadata of the contract token in a hashed format such that the underlying source of the video is not publicly available.

After the contract token has been mined and added to the DLP at step 408, the process can move to step 410 wherein payment due to the contributor is transmitted to the contributor’s digital wallet and the contract token is transmitted to the user’s digital wallet. Payment for licensing transaction is not limited to any one form of currency. In non-limiting examples, payment can include one or more cryptocurrencies, or one or more national currencies issued by a government entity. In one or more examples, contemporaneously with the transmittal of payment to the contributor and the contract token to the user, the digital media may also be distributed to the user.

Process 400 enables users to receive a contract token indicative of a license for certain digital media and for contributors to receive payment for such license. As this process operates within a peer-to-peer system, there is necessarily some amount of participation by the parties to a given licensing transaction. Such participation by the user and the contributor will be discussed below.

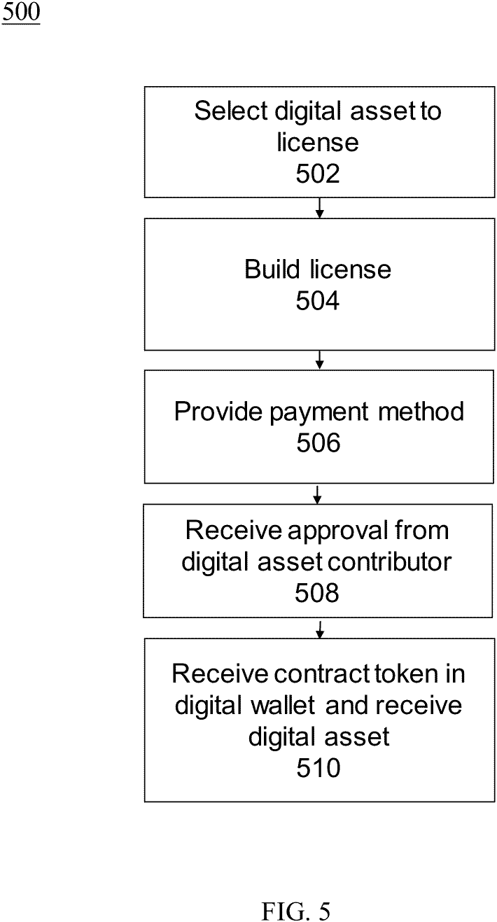

FIG. 5 illustrates an exemplary process 500 for a user to purchase licensing rights for a digital asset, in accordance with some examples. The process 500 can be employed using a user device 104 in communication with a digital marketplace such as the digital marketplace 106 of system 100. The digital marketplace 106 can include one or more available digital assets submitted by one or more contributors that are available for users to license. The available digital assets can be identified on the digital marketplace 106 in a variety of manners. For example, if the digital asset is a photograph, a non-downloadable copy of the photograph may be published to the digital marketplace 106 that includes a watermark or some other anti-copying device. Alternatively, if the digital asset is a software program, the digital asset may be identified by a description of the software. These are non-limiting examples, as a software program or a photograph may also be identified in any other manner that sufficiently identifies the digital asset to the user.

After the user selects a digital asset from the digital marketplace at step 502, the process can move to step 504 where the user can build a license for the digital asset. In one or more examples, the user can build a license using a license-builder, as discussed above. For example, the user can build a custom license tailored to their specific needs. Where a user intends to use certain digital media in a commercial application, the user can build a license that will enable the user to use the digital media in that manner. In one or more examples, the contributor of a digital asset may include licensing requirements. The licensing requirements can include, in non-limiting examples, a minimum license price, a stipulation that the license can only be non-exclusive, a requirement for royalties, etc.

After building a license at step 504, the process 500 can move to step 506 where the user can provide a payment method. In one or more examples, the contributor may specify that they will accept payment in certain types of currency. Types of currency can include, for example, a national currency issued and regulated by a government entity or one or more cryptocurrencies. In non-limiting examples, the user can specify that payment for a license should be debited from a digital wallet address associated with the user, a credit or debit card, or a bank account.

In one or more examples, when providing a payment method at step 506, the user may be prompted to link an existing digital wallet maintained on a DLP or to create a new digital wallet that is hosted on and secured by a DLP such as distributed ledger platform 108 of system 100. A digital wallet can be hosted on any DLP that enables the wallet holder to upload and maintain wallet location and retrieval information for digital assets. A DLP wallet can be maintained using cryptography. For example, a DLP wallet can rely on public-key cryptography (PKC) or asymmetric encryption. PKC involves the creation of a public key and a private key to facilitate secure digital transactions. These keys enable transition from a first public state wherein information cannot be altered (public key) to a second state wherein information can be altered by the holder of the private key. For example, when a new digital wallet is generated, a public key and private key can be created. The digital wallet will have an address that can be securely shared publicly using the public key. The private key can be used by the owner of the digital wallet to create digital signatures and verify transactions. In PKC, the private key cannot be forged. Accordingly, the owner of the private key can ensure that each transaction involving their digital wallet is authorized.

At step 508, in one or more examples, the user can receive approval from the digital asset contributor indicating that their licensing contract for the specified one or more digital assets was approved by the owner of the digital assets, as discussed above. After receiving approval from the digital asset contributor, at step 510, the user can receive a contract token in the user’s digital wallet and receive the digital asset. The user may receive the contract token in their digital wallet after the contract token has been secured via a DLP and the contract terms have been embedded as metadata into the token, as discussed above. In one or more examples, the user may receive the digital asset directly from the digital asset contributor. Alternatively, the user may receive the digital asset from a digital storage locker associated with the contributor and hosted by the digital marketplace 106.

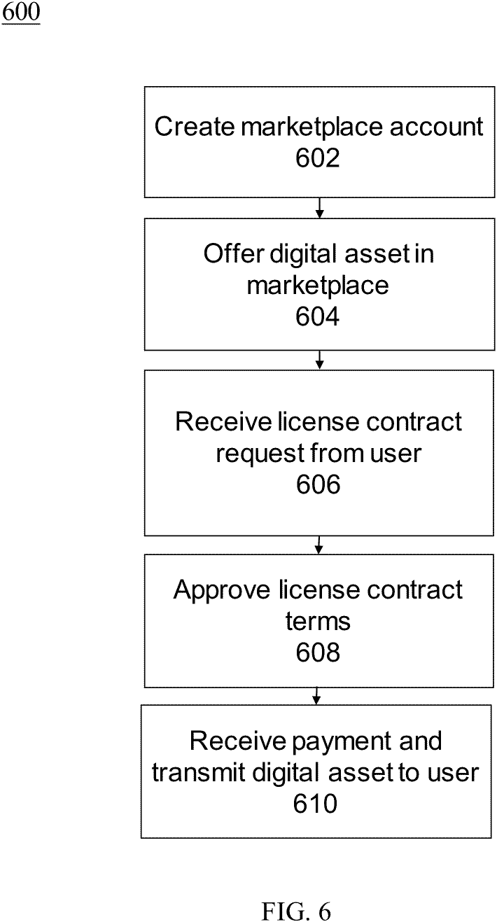

FIG. 6 illustrates an exemplary process 600 for a contributor to license a digital asset, in accordance with some examples. At step 602, the contributor can create a marketplace account. The contributor can make a marketplace account for a digital marketplace such as digital marketplace 106 of system 100 using a contributor device 102. Making a marketplace account can include, for example, providing certain identifying information and linking or establishing a digital wallet to receive payment for licensing transactions. Linking a digital wallet can include providing a digital wallet address for an existing digital wallet associated with the contributor. Alternatively, the user may be prompted to generate a digital wallet using a DLP, as explained above.

At step 604, in one or more examples, a contributor can offer a digital asset in the marketplace. The contributor may offer a digital asset within digital marketplace 106 of system 100. As discussed above, the contributor can identify the digital asset available by any means sufficient to describe the asset. The contributor may, in one or more examples, provide stipulations for one or more of their digital assets regarding licensing terms. For example, the contributor may stipulate that some or all of their digital assets can only be licensed for a specific duration. In one or more examples, the contributor may provide licensing contracts for one or more of their digital assets. The licensing contracts can be, for example, non-modifiable, or customizable standard form contracts.

In one or more examples, when offering a digital asset in the marketplace at step 604, the contributor can specify that ownership of any contract token that represents a license for that digital asset can be shared among multiple users. Ownership of a given contract token can be shared via fractionalization of the token. Fractionalization involves dividing ownership of a given token into smaller fractions and enables multiple users to share ownership of a single token through democratized shared ownership. In one or more examples, the contributor can specify a given asset can be owned by multiple users and thus permit fractionalization for any licenses purchased for that digital asset. The contributor may grant fractionalized ownership for a certain asset to multiple users that permits a certain number of uses of the asset. For example, the contributor of a photo may grant a group of users the right to use that photo fifty times for advertising campaigns. For a given asset that the contributor indicates can be licensed via fractionalization, the contributor may accept a group contract that names each user.

After offering a digital asset in the marketplace at step 604, a contributor can receive a license contract request to license the digital asset from a user at step 606. As discussed above, the contributor may approve or reject a license contract submitted by one or more users. In one or more examples, the contributor may specify that certain license contracts will be automatically approved. For example, if the contributor stipulates that their digital media can only be licensed using a certain non-modifiable contract, upon receiving a license contract request including that non-modifiable contract, the contract request may be automatically approved.

If the contributor approves the license contract terms at step 608, process 600 can proceed to step 610.

After approving the terms of a licensing contract at step 608, the contributor can receive payment and transmit the digital asset to the user, as shown in step 610. In one or more examples, the contributor may receive payment to their digital wallet. As discussed above, the user may receive the digital asset directly from the contributor, and thus step 610 can involve the contributor transmitting the digital asset to the user. Alternatively, in one or more examples, the contributor may upload their digital media to a contributor locker hosted by the digital marketplace 106 of system 100. In such examples, upon completing a licensing transaction, the digital media may automatically be transmitted to the user from the contributor’s locker by transmitting the digital media to the user device 104.

In one or more examples, and as will be described further below, a user who receives a contract token and digital media using the digital marketplace 106 of system 100, the user may decide to transfer that contract token to a third party. Private key cryptography can be used to securely facilitate such transfers. As explained above, a private key enables the holder of that key to “open” the digital wallet associated with that private key and to “spend” or transfer tokens contained within that wallet. For example, if a digital wallet contains a contract token generated as discussed above, the owner of the digital wallet (and/or holder of the private key) can unlock their digital wallet and transfer the token to another individual using the public key address of that new individual’s digital wallet.

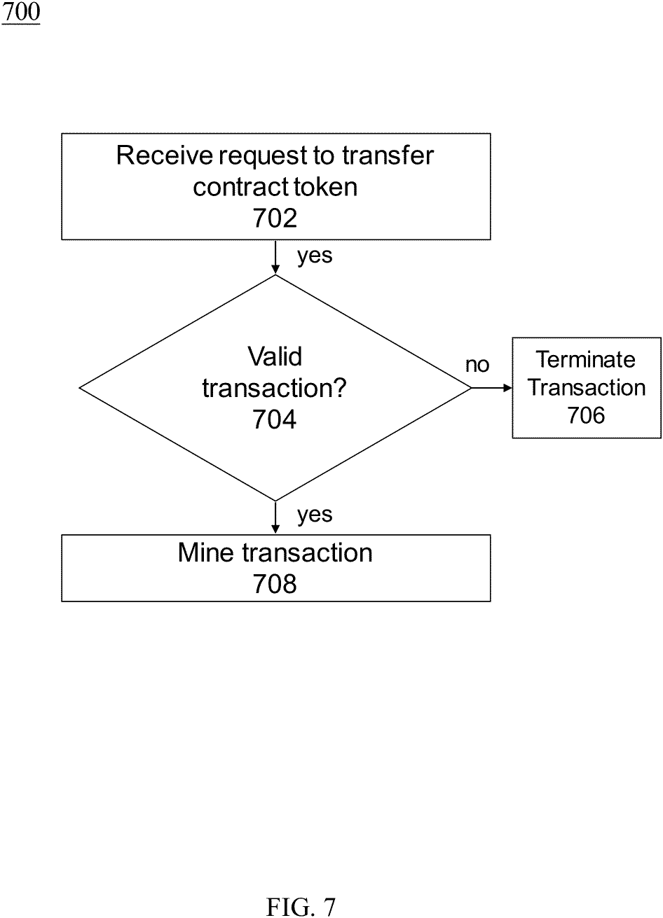

FIG. 7 illustrates an exemplary process 700 for a user to transfer a cryptographically secured contract token to a new user, in accordance with some examples. At step 702, in one or more examples, the process 700 can begin by receiving a request to transfer a specific contract token. The request to transfer the contract token can be received by a DLP such as distributed ledger platform 108 of system 100.

Once the request to transfer the contract token is received at step 702, the process can move to step 704 wherein the request can be analyzed to determine whether the transaction is valid. In one or more examples, a smart contract concerning the contract token may contain one or more contract terms regarding transferability of the contract token. For example, the smart contract can contain a trigger condition related to transferring the license to a new user with corresponding consequences such that if the user attempts to transfer the license to a new user, the consequences will occur. For example, a consequence of requesting to transfer can simply be the execution of the transfer. In one or more examples, where the smart contract requires a royalty payment to the contributor each time the contract token is transferred, the smart contract may execute the transfer and simultaneously transmit the royalty payment to a digital wallet associated with the contributor.

If the transaction is determined to be invalid, the process 700 may terminate the transaction, as shown in step 706. Alternatively, if the process 700 determines the transaction is valid, the process 700 can continue to mine the transaction at step 708. As discussed above, mining the transaction may entail publishing data regarding the transaction to the computing nodes of a distributed ledger platform which then append a validated hashed data block corresponding to the transaction to the ledger after conducting a consensus protocol. Process 700 may mine the transaction using distributed ledger platform 108 and computing notes 110 of system 100.

The process described in FIG. 7 can enable the one or more owners of a given contract token to provide a ledger record of the ownership history of the contract token. As a DLP is a public ledger, the process 700 can thus ensure that pertinent data regarding the ownership of a contract token is available for third parties to access while still protecting that ownership record from the risk of cyber-attacks or malicious use of the data. A third party who may be considering purchasing a certain license from the original buyer of the license may however require a means to access pertinent information regarding the contract token such as what smart contract terms exist regarding the contract token.

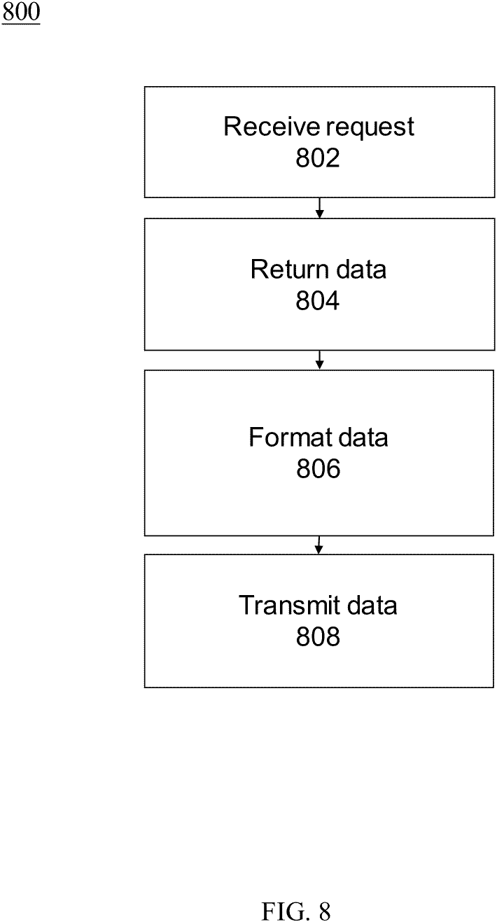

FIG. 8 illustrates an exemplary process 800 for accessing information associated with a contract token, in accordance with some examples. In one or more examples, a third party may submit a request to access information about a contract token that is contained in a DLP. The third party may submit such request using the digital marketplace 106 of system 100. Although FIG. 8 frames the process to request information regarding a contract token from the perspective of a third party, it should be understood that process 800 can also be executed by a party to the contract.

At step 802, the request for information regarding a contract token may be received. The request may be received by, or communicated to, the DLP that stores the information, such as distributed ledger platform 108 of system 100. Upon receiving a request at step 802, the process 800 can return the data associated with the request, as shown in step 804. In one or more examples, returning the data can include analyzing one or more blocks on a DLP to determine if a block contains the data requested. Upon locating one or more blocks relating to the data requested, the data can be formatted, as shown in step 806. In one or more examples, data corresponding to a contract token may be located in multiple blocks on a DLP, such as when a contract token has been transferred from the original user to one or more new users. In such example, the data formatted at step 806 can include a transfer history of the contract token that indicates the parties on each side of each transfer, as well as other identifying information such as the date of the transaction, the value exchanged, or other relevant indicia. Formatting data at step 806 can, in one or more examples, involve some form of data decryption. Once data has been formatted at step 804, the process 800 can transmit the data to the third party requestor, as shown in step 808.

In addition to transferring an existing license as shown in process 800, in one or more examples, a user may be able to upgrade their existing license. In non-limiting examples, the user may want to extend the duration of a limited duration license, or to expand the permitted use to include both commercial and retail use. To upgrade an existing license, the user may submit an upgrade contract to the digital asset contributor that indicates the proposed modifications to the contract using their user device 104 and the digital marketplace 106. The contributor may reject the upgrade contract entirely. In one or more examples, if the contributor rejects the contract the contributor may instead request that the user build an entirely new contract. Alternatively, the contributor may reject the upgrade contract and reply with suggested modifications. In further examples, the contributor may approve the upgrade contract. Upon approving an upgrade contract proposed by the existing licensee (the user) and before executing the transaction, it may be necessary to ensure that the contributor still has the right to license the asset. If the contributor does not, the transaction may be terminated. Otherwise, the transaction may be executed. The upgrade transaction may be executed similarly to a licensing transaction as discussed above. That is, the contract terms may be transformed into a smart contract, a contract token may be created and mined on a DLP, and the payment may be transmitted to the contributor’s wallet contemporaneously with the contract token corresponding to the upgrade contract being transmitted to the user’s wallet.

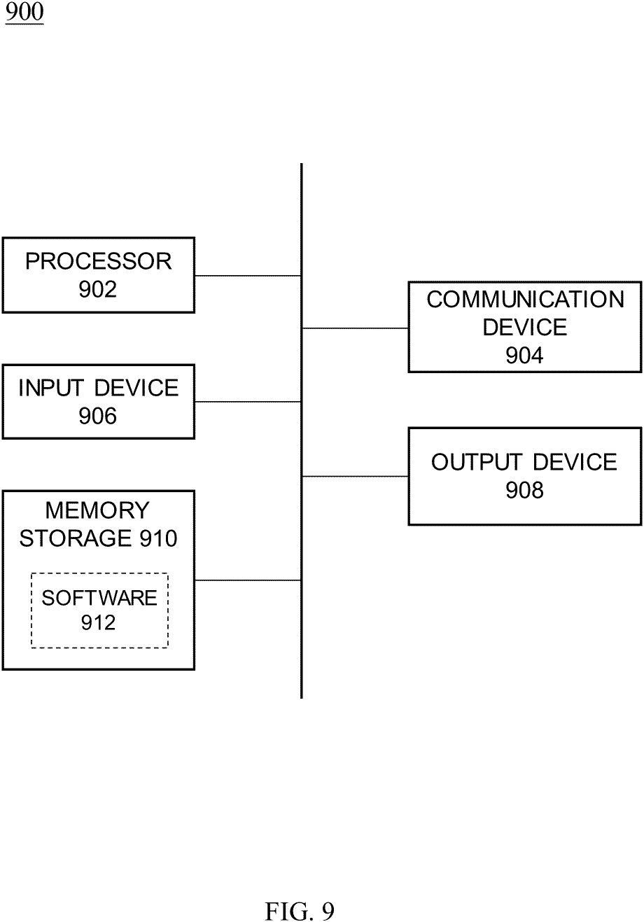

FIG. 9 illustrates an exemplary computing device 900, in accordance with some examples. Device 900 can be a host computer connected to a network. Device 900 can be a client computer or a server. As shown in FIG. 9, device 900 can be any suitable type of microprocessor-based device, such as a personal computer, workstation, server, or handheld computing device (portable electronic device) such as a phone or a tablet. The device can include, for example, one or more processors, 902, an input device 906, an output device 908, a memory storage 910, and a communication device 904.

The input device 906 and output device 908 can generally correspond to those described above and can either be connectable or integrated with the computer. The input device 906 can be any suitable device that provides input, such as a touch screen, keyboard or keypad, mouse, or voice-recognition device. The output device 908 can be any suitable device that provides output, such as a touch screen, haptics device, or speaker.

The memory storage 910 can be any suitable device that provides storage, such as an electrical, magnetic, or optical memory, including a RAM, cache, hard drive, or removable storage disk. The communication device 904 can include any suitable device capable of transmitting and receiving signals over a network, such as a network interface chip or device. The components of the computer can be connected in any suitable manner, such as via a physical bus or wirelessly.

The software 912, which can be stored in the memory storage 910 and executed by the processor 902, can include, for example, the programming that embodies the functionality of the present disclosure (e.g., as embodied in the devices as described above). The software 912 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as the memory storage 910, that can contain or store programming for use by or in connection with an instruction execution system, apparatus, or device.

The software 912 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

The device 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

The device 900 can implement any operating system suitable for operating on the network. The software 912 can be written in any suitable programming language, such as C, C++, Java, or Python. In various examples, application software embodying the functionality of the present disclosure can be deployed in different configurations, such as in a client/server arrangement or through a Web browser as a Web-based application or Web service, for example.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Some examples of the disclosure are directed to a method for generating a secured contract token, the method comprising: receiving contract terms for a transaction between a first user and a second user, wherein the transaction comprises an asset owned by the first user that is being conveyed to the second user; generating an executable file that is configured to be executed by a computing processor based, at least in part, on the received contract terms; storing the executable file in a memory; generating a digital contract token, wherein the digital contract token is an electronic file comprising metadata, wherein a content of the metadata is based on the received contract terms and the generated executable file; transmitting the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process; receiving a confirmation from the distributed ledger network that the transaction was authenticated; and upon receiving the confirmation, transmitting the generated digital contract token to a digital wallet of the second user.

Some examples of the disclosure are directed to a system for generating a secured contract token, the system comprising: a memory; one or more processors; and one or more programs, wherein the one or more programs are stored in the memory and configured to be executed by the one or more processors, the one or more programs when executed by the one or more processors cause the processor to: receive contract terms for a transaction between a first user and a second user, wherein the transaction comprises an asset owned by the first user that is being conveyed to the second user; generate an executable file that is configured to be executed by a computing processor based, at least in part, on the received contract terms; store the executable file in a memory; generate a digital contract token, wherein the digital contract token is an electronic file comprising metadata, wherein a content of the metadata is based on the received contract terms and the generated executable file; transmit the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process; receive a confirmation from the distributed ledger network that the transaction was authenticated; and upon receiving the confirmation, transmit the generated digital contract token to a digital wallet of the second user.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

This application discloses several numerical ranges in the text and figures. The numerical ranges disclosed inherently support any range or value within the disclosed numerical ranges, including the endpoints, even though a precise range limitation is not stated verbatim in the specification, because this disclosure can be practiced throughout the disclosed numerical ranges.

The above description is presented to enable a person skilled in the art to make and use the disclosure, and it is provided in the context of a particular application and its requirements. Various modifications to the preferred examples will be readily apparent to those skilled in the art, and the generic principles defined herein may be applied to other examples and applications without departing from the spirit and scope of the disclosure. Thus, this disclosure is not intended to be limited to the examples shown but is to be accorded the widest scope consistent with the principles and features disclosed herein. Finally, the entire disclosure of the patents and publications referred in this application are hereby incorporated herein by reference.

1. A method for generating a digital contract token, the method comprising:
receiving contract terms for a transaction between a first user and a second user, wherein the transaction comprises an asset owned by the first user that is being conveyed to the second user;
generating an executable file that is configured to be executed by a computing processor based, at least in part, on the received contract terms;
storing the executable file in a memory;
generating a digital contract token, wherein the digital contract token is an electronic file comprising metadata, wherein a content of the metadata is based on the received contract terms and the generated executable file;
transmitting the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process;
receiving a confirmation from the distributed ledger network that the transaction was authenticated; and
upon receiving the confirmation, transmitting the generated digital contract token to a digital wallet of the second user.

2. The method of claim 1, wherein each computing node of the plurality of computing nodes of the distributed ledger network is configured to create the local copy of the electronic ledger by applying a cryptographic hash function to the data received by the distributed ledger network and storing an output of the cryptographic hash function in the local copy of the electronic ledger.

3. The method of claim 2, wherein the consensus process involves each computing node of the plurality of computing nodes of the distributed ledger network determining if the output of the cryptographic hash function stored in each local copy at each computing nodes of the plurality of computing nodes of the distributed ledger network are in agreement with each other, and wherein if it is determined that each local copy at each computing node of the plurality of computing nodes of the distributed ledger network are in agreement with each other, the transaction is authenticated.

4. The method of claim 1, wherein the distributed ledger network comprises a read-only database.

5. The method of claim 1, wherein the contract terms comprise one or more conditions for the second user to license an asset from the first user.

6. The method of claim 1, wherein the contract terms include at least some terms populated by a license-builder and agreed-upon by the first user and the second user.

7. The method of claim 1, wherein the method comprises associating a public key of a public key cryptography scheme with the digital contract token and associating a private key of the public key cryptography scheme with the digital contract token and with the second user, the private key enabling the second user to distribute the digital contract token.

8. The method of claim 1, wherein generating an executable file comprises transforming the contract terms into executable software code including one or more trigger conditions and corresponding consequences, such that if a trigger condition occurs, the corresponding consequence will automatically be executed.

9. A system for generating a digital contract token, the system comprising:
a memory;
one or more processors; and
one or more programs, wherein the one or more programs are stored in the memory and configured to be executed by the one or more processors, the one or more programs when executed by the one or more processors cause the processor to:
receive contract terms for a transaction between a first user and a second user, wherein the transaction comprises an asset owned by the first user that is being conveyed to the second user;
generate an executable file that is configured to be executed by a computing processor based, at least in part, on the received contract terms;
store the executable file in a memory;
generate a digital contract token, wherein the digital contract token is an electronic file comprising metadata, wherein a content of the metadata is based on the received contract terms and the generated executable file;
transmit the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process;
receive a confirmation from the distributed ledger network that the transaction was authenticated; and
upon receiving the confirmation, transmit the generated digital contract token to a digital wallet of the second user.

10. The system of claim 9, wherein each computing node of the plurality of computing nodes of the distributed ledger network is configured to create the local copy of the electronic ledger by applying a cryptographic hash function to the data received by the distributed ledger network and storing an output of the cryptographic hash function in the local copy of the electronic ledger.

11. The system of claim 10, wherein the consensus process involves each computing node of the plurality of computing nodes of the distributed ledger network determining if the output of the cryptographic hash function stored in each local copy at each computing nodes of the plurality of computing nodes of the distributed ledger network are in agreement with each other, and wherein if it is determined that each local copy at each computing node of the plurality of computing nodes of the distributed ledger network are in agreement with each other, the transaction is authenticated.

12. The system of claim 9, wherein the distributed ledger network comprises a read-only database.

13. The system of claim 9, wherein the contract terms comprise one or more conditions for the second user to license an asset from the first user.

14. The system of claim 9, wherein the contract terms include at least some terms populated by a license-builder and agreed-upon by the first user and the second user.

15. The system of claim 9, wherein the one or more programs when executed by the one or more processors cause the processor to associate a public key of a public key cryptography scheme with the digital contract token and associate a private key of the public key cryptography scheme with the digital contract token and with the second user, the private key enabling the second user to distribute the digital contract token.

16. The system of claim 9, wherein generating an executable file comprises transforming the contract terms into executable software code including one or more trigger conditions and corresponding consequences, such that if a trigger condition occurs, the corresponding consequence will automatically be executed.

17. A computer readable storage medium storing one or more programs for generating a digital contract token, the one or more programs comprising instructions which, when executed by an electronic device with a display and a user input interface, cause the device to:
receive contract terms for a transaction between a first user and a second user, wherein the transaction comprises an asset owned by the first user that is being conveyed to the second user;
generate an executable file that is configured to be executed by a computing processor based, at least in part, on the received contract terms;
store the executable file in a memory;
generate a digital contract token, wherein the digital contract token is an electronic file comprising metadata, wherein a content of the metadata is based on the received contract terms and the generated executable file;
transmit the generated digital contract token to a distributed ledger network, wherein the distributed ledger network comprises a plurality of computing nodes communicatively coupled with one another and wherein each computing node of the plurality of computing nodes of the distributed ledger stores a local copy of an electronic ledger that comprises data received by the distributed ledger network and wherein each computing node of the plurality of computing nodes of the distributed ledger network are configured to authenticate transactions involving the generated digital contract token using a consensus process;
receive a confirmation from the distributed ledger network that the transaction was authenticated; and
upon receiving the confirmation, transmit the generated digital contract token to a digital wallet of the second user.

18. The computer readable storage medium of claim 17, wherein each computing node of the plurality of computing nodes of the distributed ledger network is configured to create the local copy of the electronic ledger by applying a cryptographic hash function to the data received by the distributed ledger network and storing an output of the cryptographic hash function in the local copy of the electronic ledger.

19. The computer readable storage medium of claim 18, wherein the consensus process involves each computing node of the plurality of computing nodes of the distributed ledger network determining if the output of the cryptographic hash function stored in each local copy at each computing nodes of the plurality of computing nodes of the distributed ledger network are in agreement with each other, and wherein if it is determined that each local copy at each computing node of the plurality of computing nodes of the distributed ledger network are in agreement with each other, the transaction is authenticated.

20. The computer readable storage medium of claim 17, wherein the distributed ledger network comprises a read-only database.

21. The computer readable storage medium of claim 17, wherein the contract terms comprise one or more conditions for the second user to license an asset from the first user.

22. The computer readable storage medium of claim 17, wherein the contract terms include at least some terms populated by a license-builder and agreed-upon by the first user and the second user.

23. The computer readable storage medium of claim 17, wherein the one or more programs comprise instructions which, when executed by the electronic device, cause the device to: associate a public key of a public key cryptography scheme with the digital contract token and associate a private key of the public key cryptography scheme with the digital contract token and with the second user, the private key enabling the second user to distribute the digital contract token.

24. The computer readable storage medium of claim 17, wherein generating an executable file comprises transforming the contract terms into executable software code including one or more trigger conditions and corresponding consequences, such that if a trigger condition occurs, the corresponding consequence will automatically be executed.
